(19) United States
(12) Patent Application Publication
(10) Pub. No.: US 2013/0112058 A1
(43) Pub. Date: May 9, 2013

(54) METHODS OF MANUFACTURING A GLASS SUBSTRATE

(71) Applicant: James William Brown, Painted Post, NY (US)

(72) Inventor: James William Brown, Painted Post, NY (US)

(21) Appl. No.: 13/670,794

(22) Filed: Nov. 7, 2012

Related U.S. Application Data
(60) Provisional application No. 61/557,580, filed on Nov. 9, 2011.

(51) Int. Cl. C03B 33/02

(52) U.S. Cl. 83/880

(57) ABSTRACT

Methods of manufacturing a glass substrate includes the step of providing a glass substrate with a thickness of less than or equal to about 0.4 mm and providing a scoring device including scoring wheel with an outer peripheral scoring blade including a plurality of notches radially spaced apart from one another. The method further includes the step of engaging the outer peripheral scoring blade against a face of the glass substrate with a normal force of from about 8.9 newtons to about 15.6 newtons. The method also includes the step of traversing the scoring device and the glass substrate relative to one another while maintaining the normal force such that scoring wheel rotates relative to the base while the scoring blade of the scoring wheel generates a crack having a depth that is less than the thickness of the glass substrate.

### CROSS-REFERENCE TO RELATED APPLICATIONS

This application claims the benefit of priority under 35 U.S.C. §119 of U.S. Provisional Application Ser. No. 61/557,580 filed on Nov. 9, 2011, the content of which is relied upon and incorporated herein by reference in its entirety.

### TECHNICAL FIELD

The present disclosure relates to a methods of manufacturing a glass substrate and, more particularly, to methods of manufacturing a glass substrate having a thickness of less than or equal to about 0.4 mm with a scoring wheel having a plurality of notches.

### BACKGROUND

Glass substrates are known to be produced from a glass ribbon formed during a fusion down draw process. Various scoring techniques are known to generate a crack along a score path to provide a breaking line to allow portions of the glass sheets to be broken away from one another. Known scoring techniques are typically performed using a ground or polished scoring wheel that rolls along the surface of the glass substrate in a prescribed fashion to form a score line. Thereafter, a bending force can be applied over a fulcrum acting on the score line to break away portions of the glass substrate from one another at the score line.

### SUMMARY

The following presents a simplified summary of the disclosure in order to provide a basic understanding of some example aspects described in the detailed description.

In one example aspect of the invention, a method of manufacturing a glass substrate comprises a step (I) of providing a glass substrate with a thickness of less than or equal to about 0.4 mm. The method further includes a step (II) of providing a scoring device including scoring wheel rotatably mounted to a base. The scoring wheel includes an outer peripheral scoring blade including a plurality of notches radially spaced apart from one another. The method further includes a step (III) of engaging the outer peripheral scoring blade against a face of the glass substrate with a normal force of from about 8.9 newtons to about 15.6 newtons. The method further includes a step (IV) of traversing the scoring device and the glass substrate relative to one another while maintaining the normal force such that scoring wheel rotates relative to the base while the scoring blade of the scoring wheel generates a crack having a depth that is less than the thickness of the glass substrate.

In one embodiment of the aspect, step (III) includes engaging the outer peripheral scoring blade against the face of the glass substrate with a normal force of from about 11.1 newtons to about 13.3 newtons.

In another embodiment of the aspect, step (IV) generates a crack having a depth limited to a range of from about 10% to about 15% of the thickness of the glass substrate.

In still another embodiment of the aspect, step (II) provides the scoring wheel with an outer periphery that tapers to the outer peripheral scoring blade.

In still another embodiment of the aspect, step (II) provides the outer periphery with two frustoconical walls that converge together at a taper angle to form the outer peripheral scoring blade. In one aspect, the taper angle is within a range of from about 100° to about 130°, such as from about 110° to about 120°, such as from about 110° to about 115°.

In yet another embodiment of the aspect, step (II) provides the notches such that the notches are substantially equally spaced apart from one another.

In another embodiment of the aspect, step (II) provides the plurality of notches as 8 to 300 notches that are radially spaced apart from one another.

In yet another embodiment of the aspect, step (II) provides the notches with a depth “D2” within a range of 0.001 mm≦D2≦0.02 mm.

In still another embodiment of the aspect, step (IV) includes traversing the scoring device and the glass substrate relative to one another at a relative velocity within a range of from about 125 mm/s to about 1000 mm/s.

In a further embodiment of the aspect, step (II) provides the scoring wheel with an outer diameter within a range of from about 1 mm to about 3 mm. In another embodiment of the aspect, step (II) provides the scoring wheel with an outer diameter of about 2 mm.

### BRIEF DESCRIPTION OF THE DRAWINGS

These and other aspects are better understood when the following detailed description is read with reference to the accompanying drawings, in which:

FIG. 1 is a schematic view of a method of a manufacturing a glass substrate in accordance with aspects of the present disclosure;

FIG. 2 is an enlarged side view of a scoring wheel of a scoring device illustrated in FIG. 1;

FIG. 3 is a front view of the scoring wheel of FIG. 2;

FIG. 4 is an enlarged view of a portion of the scoring wheel of FIG. 2;

FIG. 5 is a sectional view of the glass substrate along line 5-5 of FIG. 1; illustrating portions of the glass substrate being scored with the scoring device of FIG. 1;

FIG. 6 is a graph representing experimental results of the median crack depth observed using various scoring wheel designs under alternative normal forces with a 0.3 mm thick glass substrate; and

FIG. 7 is a graph representing experimental results of the crack length as a percent of the total length of the score path that was observed using various scoring wheel designs under alternative normal forces with a 0.3 mm thick glass substrate.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

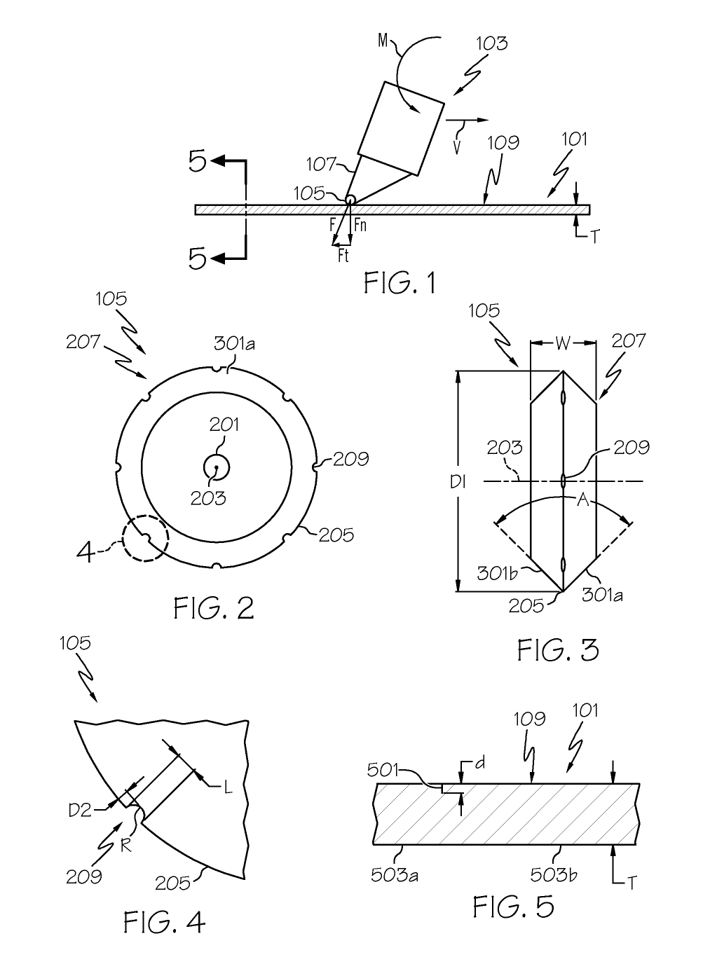

Referring now to FIG. 1, a method of manufacturing a glass substrate 101, such as a glass ribbon, glass sheet, or other substrate may be used for various applications. In one application, the glass substrate 101 is prepared for fabricating a liquid crystal display (LCD) although other applications may be provided in further examples. To form the glass substrate 101, raw material may be melted and then formed into the glass substrate 101 comprising a glass ribbon. The glass ribbon may be formed, for example, by a fusion down draw process although other forming techniques may be used in further examples. Furthermore, based on customer requirements, the glass ribbon may be cut into individual glass sheets and possibly further finished into the desired configuration. A customer may then incorporate the finished glass sheet into an LCD or other device. As such, in some examples, the glass substrate 101 may comprise a glass ribbon, glass sheet cut from the glass ribbon, and/or a finished glass sheet from the cut glass sheet although the glass substrate 101 may have further configurations in different examples.

As schematically shown in FIG. 1, the glass substrate 101 has a thickness “T” of less than or equal to about 0.4 mm. Providing a thickness “T” of less than or equal to about 0.4 mm provides a glass substrate 101 that may have reduced weight and can significantly save in material costs for producing displays when compared to displays incorporating glass substrates having a thickness of greater than 0.4 mm.

The method further includes the step of providing a scoring device 103 including a scoring wheel 105 rotatably mounted to a base 107. FIG. 1 shows a schematic side view of the scoring device 103 and scoring wheel 105 without illustrating the exact rotatable mounting arrangement between the scoring wheel 105 and the base 107. FIG. 2 illustrates an enlarged side view of one example scoring wheel 105 shown in FIG. 1. Although not necessarily to scale, the scoring wheel 105 can include an outer diameter “D1” within a range of from about 1 mm to about 3 mm. In another example, the scoring wheel 105 can include an outer diameter of about 2 mm. The scoring wheel 105 can also include a width “W” of about 0.8 mm although other dimensions may be provided depending on the particular application. The scoring wheel can be made of tungsten carbide, polycrystalline diamond (PCD) or other materials in further examples.

As shown in FIG. 2, the scoring wheel 105 can include a central mounting portion 201 that may comprise an aperture configured to receive an axle of the base 107. In further examples, the central mounting portion 201 may comprise a protrusion, such as a pin, configured to be received in apertures in the base 107. As such, various alternative configurations may be provided to allow the scoring wheel 105 to be rotatably mounted to base 107 such that the scoring wheel 105 may rotate about a rotation axis 203 of the scoring wheel 105.

As further illustrated in FIGS. 2 and 3, the scoring wheel 105 can include an outer peripheral scoring blade 205. As shown in FIG. 3, the scoring wheel 105 can be provided with an outer periphery 207 that tapers to the outer peripheral scoring blade 205 although the blade may be formed with other configurations in further examples. In one example, the outer periphery 207 can include two walls that converge together at a taper angle “A” to form the outer peripheral scoring blade 205. For instance, as shown, the two walls can optionally comprise two frustoconical walls 301a, 301b that converge together. In such examples, the outer peripheral scoring blade 205 can be formed at the intersection of the frustoconical walls 301a, 301b.

As shown in FIG. 3, the scoring wheel 105 can comprise an outer periphery 207 with a V-shaped profile having a substantially sharp blade 205 formed from a substantially sharp corner at the apex of the V-shaped profile. As such, in the illustrated example, the V-shaped profile may be formed without a deliberate step of rounding or blunting the corner that would reduce the sharpness of the corner at the apex of the V-shaped profile. In fact, in some examples, the frustoconical walls 301a, 301b may be finished (e.g., by grinding or polishing) to help maximize the sharpness of the corner and thereby provide the blade with a correspondingly enhanced sharpness.

If provided with an outer periphery 207 that tapers, as shown in FIG. 3, a taper angle “A” maybe formed within a desired range depending on the process parameters (e.g., force, glass substrate 101 thickness, material used to make the scoring wheel 105, etc.). For example, as illustrated, the taper angle “A” can be within a range of from about 100° to about 130°, such as from about 110° to about 120°, such as from about 110° to about 115°.

As shown in FIGS. 2-4, the outer peripheral scoring blade 205 can include a plurality of notches 209 radially spaced apart from one another. Various numbers of notches 209 may be provided in accordance with aspects of the disclosure. For example, that number of notches 209 can be within a range of about 8 notches to about 300 notches although other numbers of notches 209 may be provided in further examples. In the illustrated example, eight notches 209 are shown radially spaced apart from one another. Although not necessary in all examples, as shown in FIG. 2, the plurality of notches 209 may also be equally radially spaced apart from one another.

At least one notch 209 may have a different configuration from other notches 209. For example, a first set of notches 209 may have a first configuration, and a second set of notches 209 may have a second configuration, wherein the notches 209 alternate between the first and second configuration along the outer periphery 207. Alternatively, as shown in FIG. 2, the notches 209 can all be substantially identical to one another. FIG. 4 illustrates just one example notch 209 configuration. Although not necessarily to scale, the notches 209 can include a depth “D2” within a range of 0.001 mm≦D2≦0.02 mm although other depth configurations may be provided in further examples. Optionally, the notch 209 may have a radius “R” that can be substantially equal to the depth “D2” although the radius, if provided, may be less than or greater than the depth in further examples. As shown, the length “L” of the notches 209 can also optionally be equal to twice the depth “D2” although other various lengths may be provided in further examples. For instance, lengths can be provided within the range of ½·D2≦L≦3·D2 in further examples.

As shown in FIG. 1, the method of manufacturing the glass substrate further comprises the steps of engaging the outer peripheral scoring blade 205 against a face 109 of the glass substrate 101 with a normal force “Fn” of from about 8.9 newtons (e.g., about 2.0 pounds) to about 15.6 newtons (e.g., about 3.5 pounds). In another example, the method includes the step of engaging the outer peripheral scoring blade 205 against the face of the glass substrate 101 with a normal force “Fn” of from about 11.1 newtons (2.5 pounds) to about 13.3 newtons (3 pounds). Pressing the outer peripheral scoring with a lower range normal force can provide desired cracking characteristics during the scoring procedure. On the other hand, pressing the outer peripheral scoring wheel with an upper range normal force can provide sufficient cracking without completely cracking through the thickness “T” of the glass substrate 101, crushing or otherwise damaging the glass substrate 101.

The normal force “Fn” is a force component perpendicular to the face 109 of the glass sheet 101. As shown, in some examples, an applied force “F” may not be perpendicular to the face 109. Under such circumstances, the applied force “F” can include a normal force “Fn” component and a tangent force component “Ft”. In further examples, the normal force “Fn” may be generated by a moment “M” being applied to the base 107. Various mechanisms may be employed to drive the scoring wheel against the face 109. In one example, torque may be applied to a rotating member to press the outer peripheral scoring blade 205 against the face 109. In another example, a four bar linkage may be designed to force the scoring blade 205 against the face 109. Still further, as shown in FIG. 2, a piston or linear slide type device may be employed to force the scoring blade 205 against the face 109. Force can be generated by a spring, pneumatic cylinder, servo motor or other mechanisms.

As shown in FIG. 1, the method of manufacturing the glass substrate can further include the step of traversing the scoring device 103 and the glass substrate 101 relative to one another while maintaining the normal force such that scoring wheel 105 rotates relative to the base 107 while the outer peripheral scoring blade 205 of the scoring wheel 105 generates a crack having a depth that is less than the thickness “T” of the glass substrate 101.

In one example, the scoring device 103 and the glass substrate 101 can be moved relative to one another at a relative velocity “V” within a range of from about 125 mm/s to about 1000 mm/s although other relative velocities may be provided in further examples. For instance, as shown in FIG. 1, the scoring device 103 can move at a velocity “V” relative to the glass substrate 101 that may remain stationary. In further examples, the scoring device 103 may remain stationary while the glass substrate 101 is moved at the velocity “V” relative to scoring device 103. In still further examples, both the glass substrate and the scoring device may be moved with a relative velocity “V” with respect to one another. Providing the relative velocity “V” with a lower range velocity can ensure that crack depth is achieved and maintained along a substantial portion of the score path. On the other hand, providing the relative velocity “V” within a higher range velocity can reduce the processing time for the scoring process while still maintaining the same crack depth and maintenance of the crack along a substantial portion of score path.

FIG. 5 is an enlarged cross sectional view of an example crack 501 generated in the glass substrate 101 by the method of manufacturing. Although not necessarily to scale, the method may generate a crack 501 having a depth “d” limited within a range of from about 10% to about 15% of the thickness “T” of the glass substrate 101. After scoring is complete, further processing techniques may be carried out to break the glass substrate into a first portion 503a and a second portion 503b.

It was believed that a notched scoring wheel would provide an overly aggressive scoring device for thin glass substrates having a thickness of less than or equal to 0.4 mm. Indeed, it was believed that the notches designed to have intermittent contact with the glass surface for the purpose of generating a vibration-type reaction would open the median crack too much, thereby causing premature separation or breakage in thin glass sheets. However, during testing, it was found that using a scoring wheel having a plurality of notches with a glass substrate having a thickness of less than or equal to 0.4 mm unexpectedly provided desirable score features, and in fact, provided superior score features when compared to scoring the relatively thin glass substrate with a scoring wheel without notches.

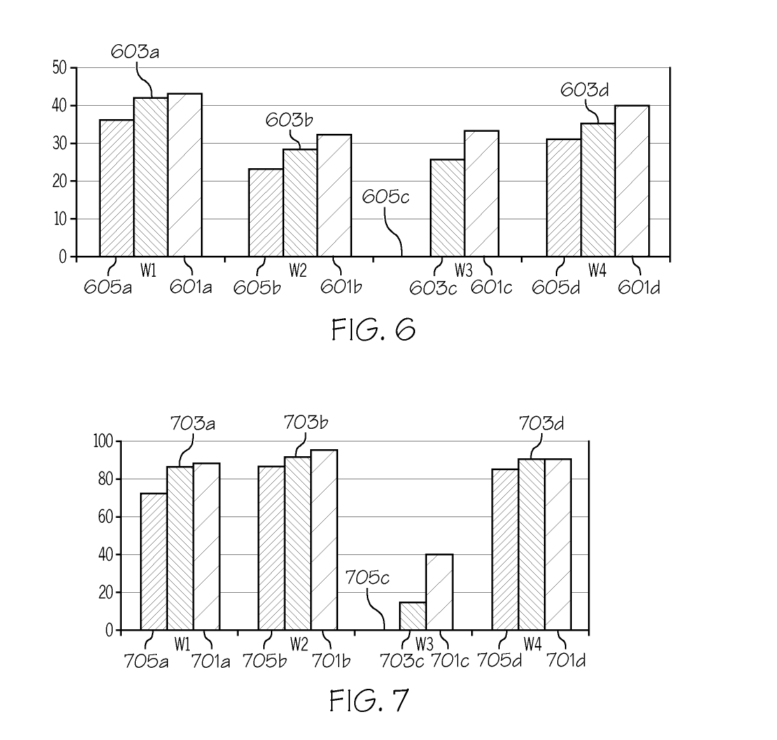

Tests were performed using four different scoring wheels W1, W2, W3 and W4. The scoring wheels W1, W2 and W4 where three different types of notched scoring wheels while the scoring wheel W3 did not include notches. The bar graph shown in FIG. 6 shows the median crack depth achieved with various normal forces applied to a 0.3 mm thick glass substrate. The average crack depth is represented by the vertical axis in microns. The bars 601a, 601b, 601c and 601d represent the median crack depth, respectively, for each of the scoring wheels W1, W2, W3 and W4 with a 3.5 pound (15.6 newton) normal force. As shown, the crack depth for each scoring wheel W1, W2, W3 and W4 with a 3.5 pound (15.6 newton) normal force achieved a crack depth of between 30 and 45 microns. The bars 603a, 603b, 603c and 603d represent the median crack depth for each of the scoring wheels W1, W2, W3 and W4 with a 3 pound (13.3 newton) normal force. As shown, the crack depth for each scoring wheel W1, W2, W3 and W4 with a 3 pound (13.3 newton) normal force achieved a crack depth of between 20 and 45 microns. The bars 605a, 605b, 605c and 605d represent the median crack depth for each of the scoring wheels W1, W2, W3 and W4 with a 2.5 pound (11.1 newton) normal force. As shown, the notched scoring wheels W1, W2 and W4 with a 2.5 pound (11.1 newton) normal force also achieved a crack depth of between 20 and 45 microns. However, as shown by the zero micron bar 605c, the scoring wheel “W3” without the notches was not successful in generating a crack in the glass substrate.

The graph shown in FIG. 7 demonstrates the success rate of creating a median crack. The glass substrate was inspected after scoring and separation to determine if a median crack is first present and then over what length this median crack is observed. Results achieving a crack over 70% of the length of the score path was considered acceptable. FIG. 7 shows the percent of the length of the score path including the crack achieved with various normal forces applied to a 0.3 mm thick glass substrate. The percent that the crack extended over the length of the score path is represented by the vertical axis in percent length (%). The bars 701a, 701b and 701d represent the percent of the length of the score path including the crack for each of the notched scoring wheels W1, W2, and W4 with a 3.5 pound (15.6 newton) normal force. The bars 703a, 703b and 703d represent the percent of the length of the score path including the crack for each of the notched scoring wheels W1, W2, and W4 with a 3 pound (13.3 newton) normal force. The bars 705a, 705b and 705d represent the percent of the length of the score path including the crack for each of the notched scoring wheels W1, W2, and W4 with a 2.5 pound (11.1 newton) normal force. As shown, all of the examples using the notched scoring wheel achieved a crack from about 70% to about 97% of the scoring path. In contrast, as shown by bar 701c, the scoring wheel “W3” without the notches only achieved a crack of about 40% of the scoring path when using a 3.5 pound (15.6 newton) normal force. Furthermore, as shown by bar 703c, the scoring wheel “W3” without the notches only achieved a crack from of between 10% and 20% of the scoring path when using a 3 pound (13.3 newton) normal force. Further, as represented by 705c, zero percent of the scoring path include a crack with the notchless scoring wheel “W3” using a 2.5 pound (11.1 newton) normal force. It is believed that the scoring wheel “W3” without the notches provided undesirable results because local glass bending at the scoring wheel tip would result; thereby creating a significant compressive stress on the sheet surface. This compressive stress is believed to prevent the scoring wheel from creating and/or maintaining a median crack in the relatively thin glass substrate.

Moreover, as demonstrated in the test results above, it was unexpectedly found that using a scoring wheel including an outer peripheral scoring blade with a plurality of notches was effective for use with a glass substrate having a thickness of less than about 0.4 mm. More particularly, the notched scoring wheel provided a desirable median crack depth from about 10% to about 15% of the thickness of the glass substrate with a thickness of less than about 0.4 mm. At the same time, the normal force required to achieve this median crack depth was reduced when compared to a score wheel without notches. Reducing the normal force required to provide the desired crack depth can be desirable to avoid the compressive stress or bending that would otherwise occur with the relatively thin glass substrates.

It will be apparent to those skilled in the art that various modifications and variations can be made without departing from the spirit and scope of the claimed invention.

What is claimed is:

1. A method of manufacturing a glass substrate comprising the steps of:
(I) providing a glass substrate with a thickness of less than or equal to about 0.4 mm;
(II) providing a scoring device including scoring wheel rotatably mounted to a base, the scoring wheel including an outer peripheral scoring blade, with the outer peripheral scoring blade including a plurality of notches radially spaced apart from one another;
(III) engaging the outer peripheral scoring blade against a face of the glass substrate with a normal force of from about 8.9 newtons to about 15.6 newtons; and
(IV) traversing the scoring device and the glass substrate relative to one another while maintaining the normal force such that scoring wheel rotates relative to the base while the scoring blade of the scoring wheel generates a crack having a depth that is less than the thickness of the glass substrate.

2. The method of claim 1, wherein step (III) includes engaging the outer peripheral scoring blade against the face of the glass substrate with a normal force of from about 11.1 newtons to about 13.3 newtons.

3. The method of claim 1, wherein step (IV) generates a crack having a depth limited to a range of from about 10% to about 15% of the thickness of the glass substrate.

4. The method of claim 1, wherein step (II) provides the scoring wheel with an outer periphery that tapers to the outer peripheral scoring blade.

5. The method of claim 4, wherein step (II) provides the outer periphery with two frustoconical walls that converge together at a taper angle to form the outer peripheral scoring blade.

6. The method of claim 5, wherein step (II) provides the taper angle within a range of from about 100° to about 130°.

7. The method of claim 6, wherein step (II) provides the taper angle within a range of from about 110° to about 120°.

8. The method of claim 7, wherein step (II) provides the taper angle within a range of from about 110° to about 115°.

9. The method of claim 1, wherein step (II) provides the notches such that the notches are substantially equally spaced apart from one another.

10. The method of claim 1, wherein step (II) provides the plurality of notches as 8 to 300 notches that are radially spaced apart from one another.

11. The method of claim 1, wherein step (II) provides the notches with a depth “D2” within a range of 0.001 mm≦D2≦0.02 mm.

12. The method of claim 1, wherein step (IV) includes traversing the scoring device and the glass substrate relative to one another at a relative velocity within a range of from about 125 mm/s to about 1000 mm/s.

13. The method of claim 1, wherein step (II) provides the scoring wheel with an outer diameter within a range of from about 1 mm to about 3 mm.

14. The method of claim 13, wherein step (II) provides the scoring wheel with an outer diameter of about 2 mm.
